(19) United States
(12) Patent Application Publication
(10) Pub. No.: US 2020/0285684 A1
(43) Pub. Date: Sep. 10, 2020

(54) Method And System For Distributing And Presenting Confidential Information On The Internet

(71) Applicant: Curiositas Ltd Oy, Tampere (FI)

(72) Inventors: Antero Hälikkä, Tampere (FI); Jari Welling, Tampere (FI)

(21) Appl. No.: 16/812,391

(22) Filed: Mar. 9, 2020

(30) Foreign Application Priority Data
Mar. 8, 2019 (FI) 20197045

(51) Int. Cl. G06F 16/9538; H04W 76/12; H04L 12/58; H04L 29/06; H04L 29/08; G06F 21/62; G06F 16/958

(52) U.S. Cl. CPC G06F 16/9538; H04W 76/12; H04L 51/22; H04L 65/1069; H04W 84/042; G06F 21/6218; G06F 16/972; H04L 67/02; H04L 67/06

(57) ABSTRACT

According to an example aspect of the present invention, there is provided a method to collect and present information using a system on the internet, the method comprising the steps of providing an invitation link to at least one invited uploader, said link leading to a file folder within a file repository service and said link comprising at least one unique security mark, said security mark being randomly generated for each invited uploader, and said file repository service configured to accept tunneled connections on a public network to connect to said file folder, identifying at least one invited uploader accessing the folder via an authorization given from the service and said unique security mark, wherein the file repository service is configured so that each at least one invited uploader is able to view and edit only the files uploaded by said invited uploader, said files comprising the unique security mark corresponding to the invited uploader, and wherein the file folder administrator is able to view and edit all the files within the folder and wherein the file folder administrator is able to add files into the file folder, said files comprising at least one of the unique security marks and said files being viewable by the corresponding invited uploader.

### FIELD

This disclosure provides a method of distributing information, in particular in the field of remote meeting applications.

More specifically, the present disclosure provides a combination of methods and a system with which confidential electronic documents such as files are collected using encrypted connections on a public network from a restricted or an open user group invited by email in which case invitations are valid only for the duration of a predetermined time or with the invited logged into a service for a certain purpose. The distributors of information do not see each other's information including the identities of others who have distributed information.

### BACKGROUND

On a public network, there exist services that can be used to distribute files among their users. For example, it has been possible to distribute free software on services that do not require signing up. On these services, any information is available to anyone, which is why they are not suitable for the distribution of confidential information.

There exists more limited type of services, the users of which are required to sign up and use a username and password pair created at registration to prove that they are members of the user community. On this type of services, the distributors of information would be required to register even if they only needed to use the service once.

Sometimes, it is also necessary to collect files on a certain topic from several distributors such as offers or presentations from several suppliers or various types of confidential reports, in which case each of them will have to be given a separate password-protected destination to deliver their information to on the internet, so as not to reveal the information to other distributors of information, and that a distributor would maintain the right to edit a file that he/she has sent. An anonymous consultation service may be necessary in which the user wishes to stay anonymous due to the sensitivity of the issue at hand.

Information requests must be thus identified. Opening the collected information for review, comparison or presentation on part of the collector requires opening the files one by one from different folders or transferring the files into a single folder named after the topic or by printing them. Presenting files over the internet as pdf files, for instance, is possible but laborious if they have to be fetched from different folders.

The invention presented in the application is a solution to the aforementioned problems. The requested files are collected into a single address and folder on an internet application with individual logging credentials with individual identifying metadata attached to each collected file which is used to separate the logged in users and prevent them from having access to each other's information. Only the data collector gets access to everyone's information in his/her file folder but each distributor/uploader only has access to his/her own files or files uploaded for him/her by the collector and he/she cannot see files distributed by others within the filename list.

### SUMMARY OF THE INVENTION

The invention is defined by the features of the independent claims. Some specific embodiments are defined in the dependent claims.

According to a first aspect of the present invention, there is provided a method to collect and present information using a system on the internet, the method comprising the steps of: providing an invitation link to at least one invited uploader, said link leading to a file folder within a file repository service and said link comprising at least one unique security mark, said security mark being randomly generated for each invited uploader, and said file repository service configured to accept tunneled connections on a public network to connect to said file folder, identifying at least one invited uploader accessing the folder via an authorization given from the service and said unique security mark, wherein the file repository service is configured so that each at least one invited uploader is able to view and edit only the files uploaded by said invited uploader, said files comprising the unique security mark corresponding to the invited uploader, and wherein the file folder administrator is able to view and edit all the files within the folder and wherein the file folder administrator is able to add files into the file folder, said files comprising at least one of the unique security marks and said files being viewable by the corresponding invited uploader.

According to a second aspect of the present invention, there is provided an apparatus comprising at least one processing core, at least one memory including computer program code, the at least one memory and the computer program code being configured to, with the at least one processing core, cause the apparatus to comprise a file repository service, said file repository service being configured to perform the following steps: providing an invitation link to at least one invited uploader from at least one folder administrator, said link leading to a file folder within a file repository service and said link comprising at least one unique security mark, said security mark being randomly generated for each invited uploader, and said file repository service configured to accept tunneled connections on a public network to connect to said file folder, identifying at least one invited uploader accessing the folder via an authorization given from the service and said unique security mark, wherein the file repository service is configured so that each at least one invited uploader is able to view and edit only the files uploaded by said invited uploader, said files comprising the unique security mark corresponding to the invited uploader, and the at least one folder administrator is able to view and edit all the files within the folder and wherein at least one folder administrator is able to add files into the file folder, said files comprising at least one of the unique security marks and said files being viewable by the corresponding invited uploader.

According to a third aspect of the present invention, there is provided a non-transitory computer readable medium having stored thereon a set of computer readable instructions that, when executed by at least one processor, cause an apparatus to comprise a file repository service, said file repository service being configured to perform the following steps: providing an invitation link to at least one invited uploader from at least one folder administrator, said link leading to a file folder within a file repository service and said link comprising at least one unique security mark, said security mark being randomly generated for each invited uploader, and said file repository service configured to accept tunneled connections on a public network to connect to said file folder, identifying at least one invited uploader accessing the folder via an authorization given from the service and said unique security mark, wherein the file repository service is configured so that each at least one invited uploader is able to view and edit only the files uploaded by said invited uploader, said files comprising the unique security mark corresponding to the invited uploader, and the at least one folder administrator is able to view and edit all the files within the folder and wherein at least the folder administrator is able to add files into the file folder, said files comprising at least one of the unique security marks and said files being viewable by the corresponding invited uploader.

Various embodiments of the first, second or third aspect may comprise at least one feature or a combination of multiple features from the following bulleted list:
wherein the file repository service is further configured so that the file folder administrator may alter the uploaded files so that said files are visible to all invited uploaders and editable by all invited uploaders.
wherein the file repository service is further configured so that the file folder administrator may present files to invited uploaders within the internet browser of each said invited uploader.
wherein the file repository service is further configured so that the party providing the link may present files sequentially to invited uploaders within the internet browsers of said invited uploaders by selecting files to be presented and determining a sequence in which said files are to be presented.
wherein the file repository service is further configured so that the invitation link leads to a web page wherein the invited user must log in with a predetermined or programmatically generated password.
wherein the file repository service is further configured so that each uploaded file is encrypted when uploaded into the file folder.
wherein the file repository service is further configured so that the encryption is asymmetric and wherein only the file folder administrator may decrypt the uploaded files.
wherein the file repository service is further configured so that the file folder may be copied, wherein the copy of the file folder may be configured so that the files within the copied folder are visible to all invited uploaders and editable by all invited uploaders.
wherein the file repository service is further configured so that after a predetermined time set by the folder administrator the files within the folder will be made visible to all invited uploaders, or visible to and editable by all invited uploaders.

### BRIEF DESCRIPTION OF THE DRAWINGS

FIG. 1 illustrates a schematic view of an exemplary communication between the file collector and distributor in accordance with at least some embodiments of the present invention;

FIG. 2 illustrates an exemplary interaction of three internet browsers with a service providing secure data storage capable of supporting at least some embodiments of the present invention, and

FIG. 3 illustrates an exemplary presentation of files by a collector to those invented to take part in a session over the internet, and

FIG. 4 is a flow graph illustrating an exemplary method in accordance with the invention.

### EMBODIMENTS

A collector of information can distribute information as such or processed either to the same or another invited and restricted group or anyone who has uploaded their files by using commonly available internet browsers.

The nature of the invention includes a property that makes it possible for an edited or a new file to be presented by the collector over the internet to a random unknown distributor of files. A collector can publish a file he/she has selected to appear on the presentation page, the original of which can be opened by its known or anonymous distributor with his/her own access credentials with a web browser of his/her own after a given time period, for example. A collector can activate the files to be shown in a browser window for each distributor separately or for all to see by selecting the files one by one from a list of names according to filename.

All connections to the service are secure. Files may be transferred over normal short-lived HTTPS connections. In addition, a real-time socket connection is used for control messaging for the duration of a session.

The functioning of the invented method and system is described in more detail in drawings in which,

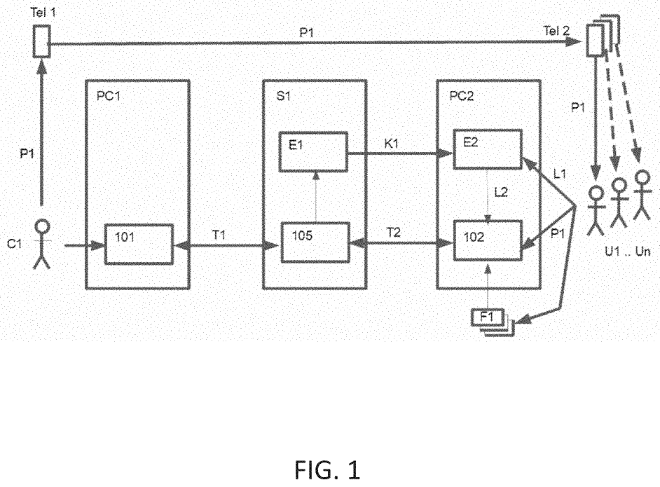

FIG. 1 presents communication between the file collector and distributor,

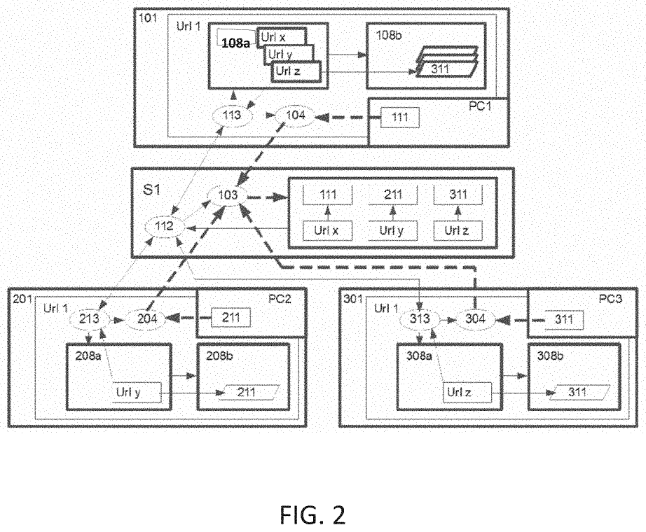

FIG. 2 presents interaction of three internet browsers with a service providing secure data storage,

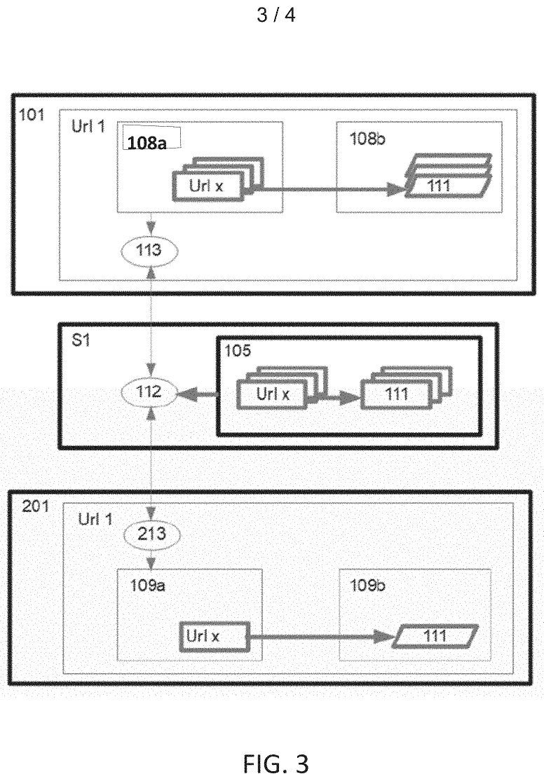

FIG. 3 shows the presentation of files by a collector to those invented to take part in a session over the internet.

In FIG. 1, an exemplary system in accordance with this disclosure is shown wherein an exemplary interaction involving collector C1 and distributor U1 has been presented. The system enables the simultaneous activity of several invitees. Within the present disclosure, the following terms may be used interchangeably: invitee, distributor, invited uploader. Within the present disclosure, the following terms may be used interchangeably: collector, inviter, file folder administrator.

Inviter C1 on his/her computer PC1 opens a secure HTTPS connection on a web browser 101 to service S1 and writes invitation K1, defines distributor U1 as the recipient and sends a message using the email sending functionality of service S1. It is possible to send the same invitation K1 to several invitees at once. Alternatively, the collector C1 can copy the content of the invitation to the clipboard and attach it to his/her own email. Link L1 is in the invitation that the invitee U1 can click to access the login page of server S1. In this example, server S1 has added a security mark as a parameter to the URL in an invitation, which is tied to the email address of the recipient, for example, which makes it possible to log in using the password P1. Based on the presence of the security mark, the service grants login rights and shows only invitee U1 the files that belong to him/her. Therefore the security mark allows the invitee to log in using password P1.

The security mark can be randomly generated or be based on JWT (JSON Web Token) authorization. Collector C1 sends password P1 to the invitee U1 either in a text message, in a letter, or in a phone call. Alternatively, the security mark can be parametrized with a random password given on the login page which can also be pre-generated for the downloader of a file to be written down or as password P1 that he/she has created for him/herself. The collector C1 can, in invitation K1, present a list of the desired files but C1 can also present their wish by email, on the telephone or otherwise. Collector C1 can use the user interface of the service to select and retrieve a file to be edited or replaced by a new one by its name and upload it to the server under the same name or another.

After receiving an invitation, the invitee U1 can use the service for the duration of the invitation according to his/her user privileges. Among the user privileges are uploading files, removing one's own files and downloading them.

The uploading of files onto the server is done according to usual methods of web browsers. For example the files may be uploaded by clicking a link in the file folder view that starts the uploading when invitee U1 is shown a list of files and directories on computer PC2. Invitee U1 can select one or more files from the list to be uploaded to server S1.

Within the files to be uploaded to server S1 by the invitee U1 is comprised a security mark related to link L1 which is included in invitation K1, added during logging in, which binds invitee U1 as the uploader of the files. The files will become part of collector C1's view, which will show files from other uploaders as well. Invitee U1 will see in his/her own view only those files he/she has uploaded him/herself. In certain forms of service, such as remote consulting, collector C1 can edit the files he has received with the access rights of the uploader and upload them under a new name to be retrieved by the original uploader U1, for example, when advice is asked and given. In at least some exemplary embodiments the collector can edit the uploaded files or, additionally or alternatively a copy of the uploaded files within the file folder, so that the files are visible to everyone within the file folder.

To further ensure data security, invitee U1 can encrypt his/her files with the encryption functionalities available in the control view. The service provides an option to use symmetrical encryption as well as an option to use asymmetrical encryption. The encrypted files are still visible to invitee U1 but only collector C1 can decrypt the files with his/her private key. Invitee U1 can remove the files he/she has encrypted and, if so desired, upload a new unencrypted file to replace them.

FIG. 2 illustrates an exemplary interaction between three internet browsers and server S1 that offers data protected space. The system provides the collector of files with a list of the identifying information of those having uploaded files to the collector's browser 101. The list of information is based on the access credentials of the uploaders. Communication between a file collector and file uploaders can be anonymous or personal communication based on file contents.

Browser 101 on the collector's computer PC1 records the session view of the founder and collector of the protected state. The view includes a list of files in frame 108a as well as the file presentation frame 108b. Said frames do not need to be visible at the same time.

The two other browsers 201 and 301 are run on the data uploaders' computers PC2 and PC3. Browser processes 104, 204 and 304 transfer the files security marked to an internet address to the collector's service through server S1 by process 103.

In file folder 105 on the server, files attached to the session folder relate to the internet addresses of the service as follows in the example case: the collector owns file 111 with address urlX on his/her browser 101, an uploader owns file 211 with address urlY on his/her browser and an uploader owns file 311 with the address urlZ on his/her browser 301.

Server process 112 is activated by browser processes 113, 213 or 313 when the browser user has selected a file from the file list to act upon. If, for example, he/she wants to download a file onto his/her own computer, this process does that in co-operation with server S1. These processes communicate with service 103 through a specific control channel that checks the security mark and implements the delivery of files to the browsers.

Browsers 201 and 301 have frames, in which the allowed file views of the file uploaders participating in the secure state are 208a and 308a, the corresponding presentation views being 208b and 308b. These do not have to be visible at the same time.

In a closed session, the following limits may be set for processes: the collector can select and show any file in a session folder. The collector can apply any functions to the selected file supported by server S1. A file uploader participating in a session folder can see, in his/her file list, those files (urlX) that were marked as public by the collector and his/her own files. The filer uploaders do not see files uploaded by other uploaders. If a collector takes control of one of the uploaded files by marking him/herself as the owner of the file, everyone will see that file.

The presentation of files by the collector over the internet to invitees to the session is presented in FIG. 3. For example, the method described in patent FI991557 can be used to present the files.

For controlling the presentation, the browsers open a control connection to the server. For example, Web Socket-technology can be used for this purpose.

In an exemplary situation wherein files are to be presented within a session collector C1 uses browser 101 and the invitee U1 uses browser 201. Both browsers are in contact with the address url1 sent by server S1. The presenter is using browser 101 and starting a presentation and he/she is selecting a document to be presented from list 108 whose address is urlX. When he/she approves of his/her selection, server process 112 on server S1 is used to search for file 111 that corresponds to the address urlX from file folder 105, and when it is found, a message is sent through the control connection to the browser processes 113 and 213, and file loading to the browsers is started in frames 108 and 109, i.e. frames 109a and 109b within browser 201. If the browser natively supports the uploaded file, it is presented within the frames. An advantage of using this method is that it is possible to entitle all participants to see all filenames and give every participant an opportunity to present any chosen file within the session.

Because the files are located in a single folder on the server, they can be presented by moving from one filename to the next. It is possible to copy a file folder, for example to a different location on the server. The copy retains its secure nature, or alternatively, the copies can be made into open file folders within the server. Functions such as copying, inviting, allowing access, generating security marks, changing the access for users may be performed by the file folder administrator at any time. Said functions may also be performed in an automatic fashion responsive to a predetermined elapsed time, for example 100 hours. Said functions may be also optionally be performed responsive to a message sent to the server via email, JSON message or websocket. Settings relative to said functions are changeable within at least one graphical user interface of the server S1.

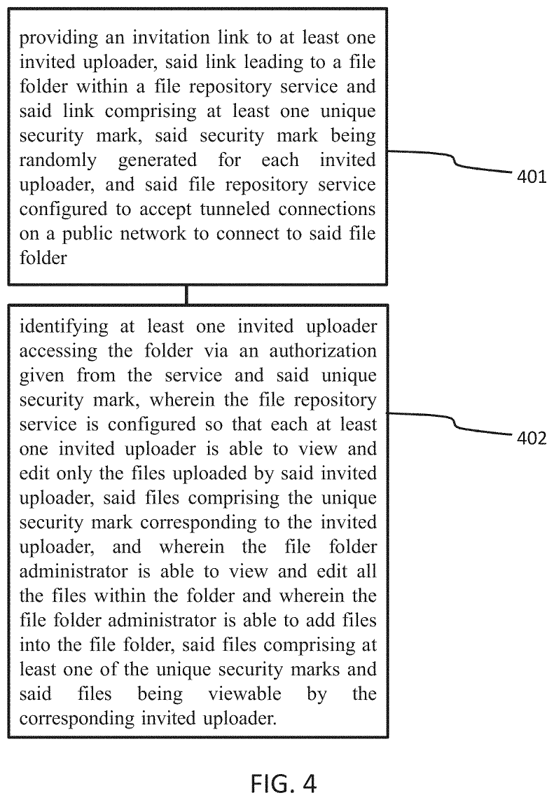

FIG. 4 shows flow graph displaying an exemplary method in accordance with at least some embodiments of the present disclosure. In step 401 of the method, an invitation link is provided to at least one invited uploader in accordance with the provision methods and the link details described elsewhere within this disclosure. In step 402 of the method, said invited uploader is identified based on

### Definitions

Tunneled connection—a secure connection is made between the user's browser and the server using, for example, the TLS (Transport Layer Security) protocol (formerly known as the SSL protocol).

The security mark of an internet address—A parameter, for example, a string made up of random characters, is attached to an address, which the service has associated beforehand with a particular email address.

Authorization—A data structure that contains metadata associated with identification and user privileges, for example. Often electronically signed and partially or completely encrypted. Packaged in such a way as to be possible to be delivered as an intact URL parameter to a server. An implementation thereof can be done in accordance with the JWT (JSON Web token) specification.

Full rights—Files are readable, editable, deletable and presentable.

Asymmetrical encryption—A file is encrypted with the public key of the creator of the file folder. The creator can unencrypt the file with his/her own private key. A large file can also be encrypted with symmetrical encryption. In that case, the encryption/decryption key is encrypted using asymmetrical encryption and delivered in a separate file.

An advantage provided by this disclosure is the ability to have within a single workspace, i.e. a network file folder, multiple confidential and simultaneous file transfers between first, second and third parties, wherein the files from the second party may be seen initially only by the first and second party and the files from the third party may be seen initially by only the first and third party. This has the effect of reducing bandwidth and computational resources required for the file sharing system as separate folders are not required and the folder administrator needs only one folder to perform the task of collecting the files. Further, as the files are encrypted as they are being uploaded, the risk of confidential information being accidentally disseminated is very low when using the present system. Finally, as the visibility of the files is also limited, the use of the presently disclosed system prevents third parties from knowing about the file transfers of other parties even when they have access to the file folder in order to upload their own files.

Control and communication between the server and browsers may be achieved in the context with disclosure in accordance with any of the following: Ethernet, RS485, serial communication, wireless communication (including but not limited to Bluetooth, WiFi), mobile wireless communication (GSM, GPRS, 3G), optical communication methods global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Comprised in the servers and personal computers disclosed herein is a processing core, which may comprise, for example, a single- or multi-core processor wherein a single-core processor comprises one processing core and a multi-core processor comprises more than one processing core. Said processor may comprise more than one processor. A processing core may comprise, for example, a Cortex-A8 processing core manufactured by ARM Holdings or a Steamroller processing core produced by Advanced Micro Devices Corporation. The processor may comprise at least one Qualcomm Snapdragon and/or Intel Atom processor. The processor may comprise at least one application-specific integrated circuit, ASIC. The processor may comprise at least one field-programmable gate array, FPGA. The processor may comprise means for performing method steps in devices. The processor may be configured, at least in part by computer instructions, to perform actions and steps of methods disclosed herein.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

The invention may be also practiced in accordance with the following clauses, which may in turn be used in combination with the aspects of the invention discussed and the bulleted list disclosed previously within the disclosure.

Clause 1. A method to collect and present information via the internet, said method comprising the following steps:
inviting, by the file folder owner, at least one file uploader using link including a security mark that makes use of randomness, wherein said link is sent to the at least one file uploader via email and wherein said link includes a URL to at least one file folder within at least one file repository,
identifying at least one said file uploader, wherein the identification is performed by the server recognizing at least one of: an authorization given from the service, a security mark,
setting permissions for files uploaded by the at least one file uploader so that said file uploader is able to view, edit or delete only his uploaded files using his own browser or corresponding application, and
setting permissions for files uploaded by the at least one file uploader so that said file folder owner is able to view, edit or delete all files within the file folder.

Clause 2. A method in accordance with any preceding clause, wherein the uploaded files are encrypted using asymmetric encryption during the uploading process or immediately after the uploading process.

Clause 3. An apparatus comprising at least one processing core, at least one memory including computer program code, the at least one memory and the computer program code being configured to, with the at least one processing core, cause the apparatus to comprise a file repository service, said file repository service being configured to perform the steps of methods of clauses 1 or 2.

Clause 4. A method to collect and present information using a system on the internet, additionally or alternatively in accordance with any preceding clause, where the data collector and file folder owner uses a tunneled connection to the sources of files on a public network with internet addresses with a security mark that makes use of randomness and to which addresses an invitation by email is sent from a server, which includes a link leading to the service webpage and a file folder when one or more file givers are identified with an authorization given from the service and a security mark, after which a file giver is able to see with his own browser or corresponding application only his own files in their file folder views and process only them, to copy and delete as one with all rights known from the collector choosing and/or getting using the service interface a file based on the filename to be edited, transferred, and/or to upload it to the server under a name and complemented with the same or another with that security mark that is based on the file giver's authorization information to keep the exchange between the file giver and collector confidential.

Clause 5. A method in accordance with any preceding clause, wherein the collector processes the files collected using full rights and adds his own files to the files, wherein the collector marks files chosen by him as public and marks himself as their owner, after which the files in question are visible to all those invited who will be able to process them with full rights.

Clause 6. A method in accordance with any preceding clause, wherein the collector is able to copy each file folder on the server with the security of the copy being the same as that of the original or it being made into a public, which allows for the visibility of the files in it to selected invitees and/or participants who are outsiders who will be able to process the files with full or limited rights and when the owner of the folder in question is able to present files supported by browsers, for example pdf files, with a real time control connection opened to the service.

Clause 7. A method in accordance with any preceding clause, wherein the collector presents files brought in the file folder view to other users logged into that file folder in a view like a slideshow by selecting each file in the file folder view from the file folder owner's file list or by stepping with an arrow in the browser view to be shown.

Clause 8. A method in accordance with any preceding clause, wherein the publishing of a link to a file folder on a separate web page from which there is a link to the file folder of the server to be logged into a given or a programmatically generated password by utilizing connections with an authorization given from the service and a security market in inputting and outputting files.

Clause 9. A method in accordance with any preceding clause, wherein encrypting each file brought into each file folder, most suitably with asymmetrical encryption or correspondingly, the decryption of which is only possible for the owner of that file folder.

### INDUSTRIAL APPLICABILITY

At least some embodiments of the present invention find industrial application in remote presenting of files over an internet connection.

REFERENCE SIGNS LIST

| | |
|---|---|
| C1 | Collector i.e. file folder administrator |
| U1 | Distributor i.e. invited uploader |
| PC1, PC2 | Personal computer |
| L1 | Link |
| K1 | Invitation |
| S1 | Server |
| P1 | Password |
| 101, 201, 301 | Browser |
| 103, 104, 113, 213, | Browser processes |
| 313, 204, 304 | |
| 105 | File folder |
| 111, 211 | File |
| urlX, urlY, urlZ | Address |
| 112 | Server process |
| 108a, 208a, 308a | File views |
| 108b, 208b, 308b | Presentation views |

1. A method to collect and present information using a system on the internet, the method comprising the steps of:
providing an invitation link to at least one invited uploader, said link leading to a file folder within a file repository service and said link comprising at least one unique security mark, said security mark being randomly generated for each invited uploader, and said file repository service configured to accept tunneled connections on a public network to connect to said file folder,
identifying at least one invited uploader accessing the folder via an authorization given from the service and said unique security mark,
wherein the file repository service is configured so that
each at least one invited uploader is able to view and edit only the files uploaded by said invited uploader, said files comprising the unique security mark corresponding to the invited uploader, and
wherein the file folder administrator is able to view and edit all the files within the folder and wherein the file folder administrator is able to add files into the file folder, said files comprising at least one of the unique security marks and said files being viewable by the corresponding invited uploader.

2. A method in accordance with claim 1, wherein the file repository service is further configured so that the file folder administrator may alter the uploaded files so that said files are visible to all invited uploaders and editable by all invited uploaders.

3. A method in accordance with claim 1, wherein the file repository service is further configured so that the file folder administrator may present files to invited uploaders within the internet browser of each said invited uploader.

4. A method in accordance with claim 3, wherein the file repository service is further configured so that the party providing the link may present files sequentially to invited uploaders within the internet browsers of said invited uploaders by selecting files to be presented and determining a sequence in which said files are to be presented.

5. A method in accordance with claim 1, wherein the file repository service is further configured so that the invitation link leads to a web page wherein the invited user must log in with a predetermined or programmatically generated password.

6. A method in accordance with claim 1, wherein the file repository service is further configured so that each uploaded file is encrypted when uploaded into the file folder.

7. A method in accordance with claim 6, wherein the file repository service is further configured so that the encryption is asymmetric and wherein only the file folder administrator may decrypt the uploaded files.

8. A method in accordance with claim 1, wherein the file repository service is further configured so that the file folder may be copied, wherein the copy of the file folder may be configured so that the files within the copied folder are visible to all invited uploaders and editable by all invited uploaders.

9. A method in accordance with claim 1, wherein the file repository service is further configured so that after a predetermined time set by the folder administrator the files within the folder will be made visible to all invited uploaders, or visible to and editable by all invited uploaders.

10. An apparatus comprising at least one processing core, at least one memory including computer program code, the at least one memory and the computer program code being configured to, with the at least one processing core, cause the apparatus to comprise a file repository service, said file repository service being configured to perform the following steps:
providing an invitation link to at least one invited uploader from at least one folder administrator, said link leading to a file folder within a file repository service and said link comprising at least one unique security mark, said security mark being randomly generated for each invited uploader, and said file repository service configured to accept tunneled connections on a public network to connect to said file folder,
identifying at least one invited uploader accessing the folder via an authorization given from the service and said unique security mark,
wherein the file repository service is configured so that
each at least one invited uploader is able to view and edit only the files uploaded by said invited uploader, said files comprising the unique security mark corresponding to the invited uploader, and
the at least one folder administrator is able to view and edit all the files within the folder and wherein at least one folder administrator is able to add files into the file folder, said files comprising at least one of the unique security marks and said files being viewable by the corresponding invited uploader.

11. An apparatus in accordance with claim 10, wherein the file repository service is further configured so that the party providing the link may alter the uploaded files so that said files are visible to all invited uploaders and editable by all invited uploaders.

12. An apparatus in accordance with claim 10, wherein the file repository service is further configured so that the party providing the link may present files to invited uploaders within the internet browser of each said invited uploader.

13. An apparatus in accordance with claim 12, wherein the file repository service is further configured so that the party providing the link may present files sequentially to invited uploaders within the internet browsers of said invited uploaders by selecting files to be presented and determining a sequence in which said files are to be presented.

14. An apparatus in accordance with claim 10, wherein the file repository service is further configured so that the invitation link leads to a web page wherein the invited user must log in with a predetermined or programmatically generated password.

15. An apparatus in accordance with claim 10, wherein the file repository service is further configured so that each uploaded file is encrypted when uploaded into the file folder.

16. An apparatus in accordance with claim 15, wherein the file repository service is further configured so that the encryption is asymmetric and wherein only the file folder administrator may decrypt the uploaded files.

17. An apparatus in accordance with claim 10, wherein the file repository service is further configured so that the file folder may be copied, wherein the copy of the file folder may be configured so that the files within the copied folder are visible to all invited uploaders and editable by all invited uploaders.

18. An apparatus in accordance with claim 10, wherein the file repository service is further configured so that after a predetermined time set by the folder administrator the files within the folder will be made visible to all invited uploaders, or visible to and editable by all invited uploaders.

19. A non-transitory computer readable medium having stored thereon a set of computer readable instructions that, when executed by at least one processor, cause an apparatus to comprise a file repository service, said file repository service being configured to perform the following steps:
providing an invitation link to at least one invited uploader from at least one folder administrator, said link leading to a file folder within a file repository service and said link comprising at least one unique security mark, said security mark being randomly generated for each invited uploader, and said file repository service configured to accept tunneled connections on a public network to connect to said file folder,
identifying at least one invited uploader accessing the folder via an authorization given from the service and said unique security mark,
wherein the file repository service is configured so that
each at least one invited uploader is able to view and edit only the files uploaded by said invited uploader, said files comprising the unique security mark corresponding to the invited uploader, and
the at least one folder administrator is able to view and edit all the files within the folder and wherein at least the folder administrator is able to add files into the file folder, said files comprising at least one of the unique security marks and said files being viewable by the corresponding invited uploader.
